(19) United States
(12) Patent Application Publication
(10) Pub. No.: US 2018/0095892 A1
(43) Pub. Date: Apr. 5, 2018

(54) PROCESSORS, METHODS, SYSTEMS, AND INSTRUCTIONS TO DETERMINE PAGE GROUP IDENTIFIERS, AND OPTIONALLY PAGE GROUP METADATA, ASSOCIATED WITH LOGICAL MEMORY ADDRESSES

(71) Applicant: Intel Corporation, Santa Clara, CA (US)

(72) Inventors: Hugh Wilkinson, Newton, MA (US); William R. Wheeler, Southborough, MA (US); Shirish Aundhe, Hillsboro, OR (US); Sandhya Viswanathan, Saratoga, CA (US); David A. Koufaty, Portland, OR (US)

(73) Assignee: Intel Corporation, Santa Clara, CA (US)

(21) Appl. No.: 15/283,355

(22) Filed: Oct. 1, 2016

(51) Int. Cl. G06F 12/1027; G06F 12/14; G06F 9/30

(52) U.S. Cl. CPC G06F 12/1027; G06F 12/145; G06F 2212/68; G06F 2212/1052; G06F 9/30145

(57) ABSTRACT

A processor of an aspect includes a decode unit to decode an instruction. The instruction is to indicate source memory address information, and the instruction to indicate a destination architecturally-visible storage location. The processor also includes an execution unit coupled with the decode unit. The execution unit, in response to the instruction, is to store a result in the destination architecturally-visible storage location. The result is to include one of: (1) a page group identifier that is to correspond to a logical memory address that is to be based, at least in part, on the source memory address information; and (2) a set of page group metadata that is to correspond to the page group identifier. Other processors, methods, systems, and instructions are disclosed.

### BACKGROUND

Technical Field

Embodiments described herein generally relate to processors. In particular, embodiments described herein generally relate to processors with support for paging.

Background Information

Many processors have memory virtualization support. With memory virtualization, software that is being performed on the processor may not access a memory directly using physical memory addresses. Instead, the software may access the memory through virtual, linear, or other logical addresses. The logical address space or memory may be divided into blocks known as pages (e.g., of one or more sizes). The pages of the logical memory may be mapped to physical memory locations, such as blocks in the physical address space or memory known as memory frames or physical frames. The logical memory addresses may be converted, through a process known as address translation, to corresponding physical memory addresses, in order to identify the appropriate physical frames or other locations in the memory.

### BRIEF DESCRIPTION OF THE DRAWINGS

The invention may best be understood by referring to the following description and accompanying drawings that are used to illustrate embodiments. In the drawings:

FIG. 1 is a block diagram illustrating that pages of a virtual memory may be logically assigned or otherwise grouped into at least two different groups, and that each of the groups may have an associated set of page group metadata, according to some embodiments.

FIG. 2 is a block flow diagram of an embodiment of a method of performing an embodiment of a page group information determination instruction.

FIG. 3 is a block diagram of an embodiment of a processor that is operative to perform an embodiment of a page group information determination instruction to store result page group metadata for an associated logical memory address.

FIG. 4 is a block diagram of a detailed example embodiment of a processor that is operative to perform an embodiment of a page group information determination instruction to store result access permissions, associated with a memory protection key, for an associated logical memory address.

FIG. 5 is a block diagram of a detailed example embodiment of a processor that is operative to perform an embodiment of a page group information determination instruction to store result metadata, associated with a memory protection key, for an associated logical memory address.

FIG. 6 is a block diagram of an embodiment of a processor that is operative to perform an embodiment of a page group information determination instruction to store a result page group identifier for an associated logical memory address.

FIG. 7 is a block diagram of an embodiment of a processor that is operative to perform an embodiment of a page group information determination instruction with a TLB miss and a page table walk.

FIG. 8 is a block diagram of an embodiment of a computer system that illustrates one possible use of a page group information determination instruction in conjunction with garbage collection.

FIG. 9A is a block diagram illustrating an embodiment of an in-order pipeline and an embodiment of a register renaming out-of-order issue/execution pipeline.

FIG. 9B is a block diagram of an embodiment of processor core including a front end unit coupled to an execution engine unit and both coupled to a memory unit.

FIG. 10A is a block diagram of an embodiment of a single processor core, along with its connection to the on-die interconnect network, and with its local subset of the Level 2 (L2) cache.

FIG. 10B is a block diagram of an embodiment of an expanded view of part of the processor core of FIG. 10A.

FIG. 11 is a block diagram of an embodiment of a processor that may have more than one core, may have an integrated memory controller, and may have integrated graphics.

FIG. 12 is a block diagram of a first embodiment of a computer architecture.

FIG. 13 is a block diagram of a second embodiment of a computer architecture.

FIG. 14 is a block diagram of a third embodiment of a computer architecture.

FIG. 15 is a block diagram of a fourth embodiment of a computer architecture.

FIG. 16 is a block diagram of use of a software instruction converter to convert binary instructions in a source instruction set to binary instructions in a target instruction set, according to embodiments of the invention.

### DETAILED DESCRIPTION OF EMBODIMENTS

Disclosed herein are embodiments of instructions, embodiments of processors to perform the instructions, embodiments of methods performed by the processors when performing the instructions, embodiments of systems incorporating one or more processors to perform the instructions, and embodiments of programs or machine-readable mediums to store or provide the instructions. In some embodiments, the processors may have logic to perform the instructions (e.g., a decode unit or other unit or other logic to decode the instruction, and an execution unit or other unit or other logic to execute or perform the instruction). In the following description, numerous specific details are set forth (e.g., specific instruction operations, types of page metadata, ways of grouping pages, processor configurations, micro-architectural details, sequences of operations, etc.). However, embodiments may be practiced without these specific details. In other instances, well-known circuits, structures and techniques have not been shown in detail to avoid obscuring the understanding of the description.

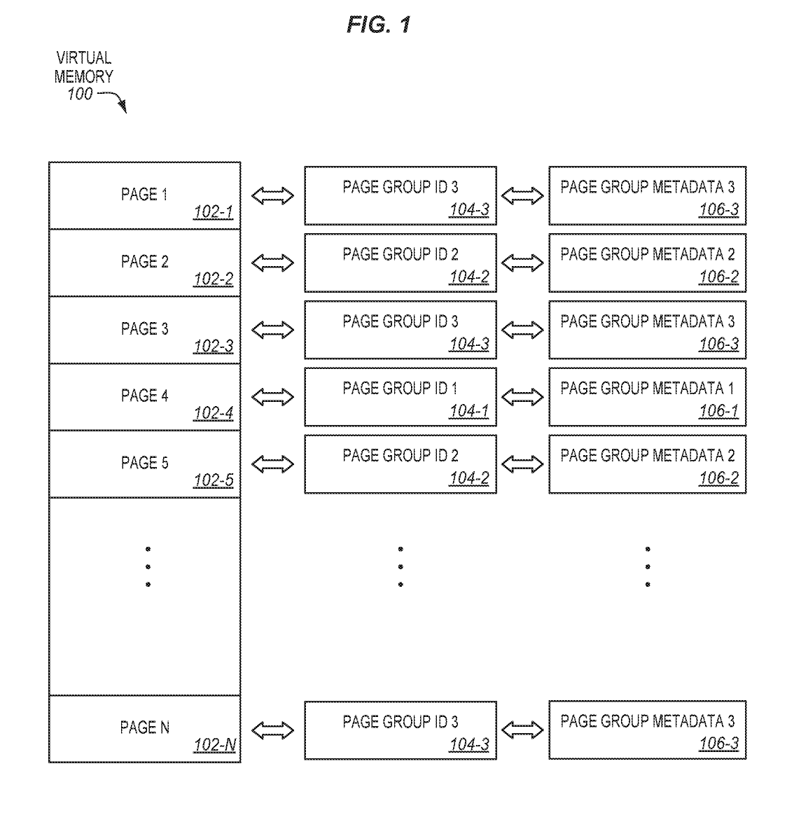

FIG. 1 is a block diagram illustrating that pages 102 of a virtual memory 100 may be logically assigned or otherwise grouped into at least two different groups (e.g., by corresponding group identifiers 104), and that each of the groups may have an associated set of page group metadata 106, according to some embodiments. The virtual memory 100 has a number of virtual memory pages 102. In the illustrated embodiment, the virtual memory has a page 1 102-1 through a page N 102-N. The number of pages (N) may vary depending upon the application, and may potentially be a very large number.

In some embodiments, the pages of the virtual memory may be logically assigned or otherwise grouped into at least two different groups. These groups may broadly represent logical buckets, bins, domains, or colors. Associating the pages of the virtual memory with the different groups is sometimes referred to as “coloring” the memory. One reason for associating the pages of the virtual memory with the different groups is so that the groups of pages may be identified or distinguished from one another, handled or processed differently from one another, or the like.

In some embodiments, each of the pages 102 of the virtual memory may be assigned or otherwise associated with a page group identifier (ID) 104. By way of example, in the illustrated embodiment, page 1 102-1 is associated with a third page group ID 3 104-3, page 2 102-2 is associated with a second page group ID 2 104-2, page 3 102-3 is associated with the third page group ID 3 104-3, page 4 102-4 is associated with a first page group ID 1 104-1, page 5 102-5 is associated with the second page group ID 2 104-2, and page N 102-N is associated with the third page group ID 3 104-3. As one specific example, the page group IDs may represent the protection keys, supported by IA-32e compliant processors (e.g., as are available from Intel Corporation, of Santa Clara, Calif.), which may be associated with user-level linear addresses and/or pages of linear or virtual memory, although the scope of the invention is not so limited.

In this example, there are three page groups and three corresponding page group IDs, although there may optionally be fewer or more than three. For example, in various embodiments, there may optionally be two, four, five, six, seven, eight, sixteen, thirty-two, or more than thirty-two, page groups and corresponding page group IDs. The page group IDs may have a number of bits sufficient to uniquely distinguish each of the groups. For example, a 1-bit page group ID may be used for two page groups, a 2-bit page group ID may be used for up to four page groups, a 3-bit page group ID may be used for up to eight page groups, a 4-bit page group ID may be used for up to sixteen page groups, and a 5-bit page group ID may be used for up to thirty-two page groups. By way of example, the protection keys in IA-32e each have 4-bits, and are used to identify any one of sixteen groups or protection keys, although the scope of the invention is not so limited.

In some embodiments, each of the page groups may correspond to, or otherwise be associated with, a set of page group metadata 106. By way of example, in the illustrated embodiment, the third page group ID 3 104-3 is associated with a third set of page group metadata 3 106-3, the second page group ID 2 104-2 is associated with a second set of page group metadata 2 106-2, and the first page group ID 1 104-1 is associated with a first set of page group metadata 1 106-1. Each set of page group metadata may include data (e.g., one or more bits) describing or specifying properties or aspects about the corresponding or associated page group.

A wide variety of different types of metadata are suitable. By way of example, in some embodiments, the metadata may include access permissions that control whether or not one or more types of accesses to the associated linear address and/or its corresponding page of the associated page group is permitted. As one specific example, in the IA-32e compliant processors previously mentioned, each of the sixteen protection keys may correspond to a set of access permissions, specifically a read-disable bit and an access-disable bit, that apply to the corresponding user-level linear addresses and/or its corresponding page of virtual or linear memory, although the scope of the invention is not so limited.

As another example, in some embodiments, the metadata may include one or more application-specific bits, indications, or information. For example, in some embodiments, the metadata may include one or more bits to provide one or more indications, hints, or information to an algorithm, application, or other software, or to the processor, about a linear, virtual, or other logical memory address range and/or its corresponding page(s). As one specific example, the metadata may optionally include one or more bits to indicate, convey, or provide information to an application or software about garbage collection associated with the logical memory address and/or its corresponding page, such as, for example, about whether the logical memory address and/or its corresponding page is in an evacuation region of garbage collection and/or whether it is possible to access the logical memory address and/or its corresponding page.

Similarly, other application-specific information or indications may optionally be included in the metadata for other types of applications or algorithms. As another specific example, the metadata may optionally include one or more bits to indicate, convey, or provide information to an application or software about whether a logical memory address and/or its corresponding page is being shared by another process. As yet another specific example, the metadata may optionally include one or more bits to indicate, convey, or provide information to an application or software about whether a logical memory address and/or its corresponding page is in a fast portion of memory or a slow portion of memory (e.g., in the case of non-uniform memory access (NUMA)). Other types of metadata to provide information about logical memory addresses and/or their corresponding pages for other types of algorithms, applications, software, or the processor, are also contemplated, and will be apparent to those skilled in the art having the benefit of the present disclosure.

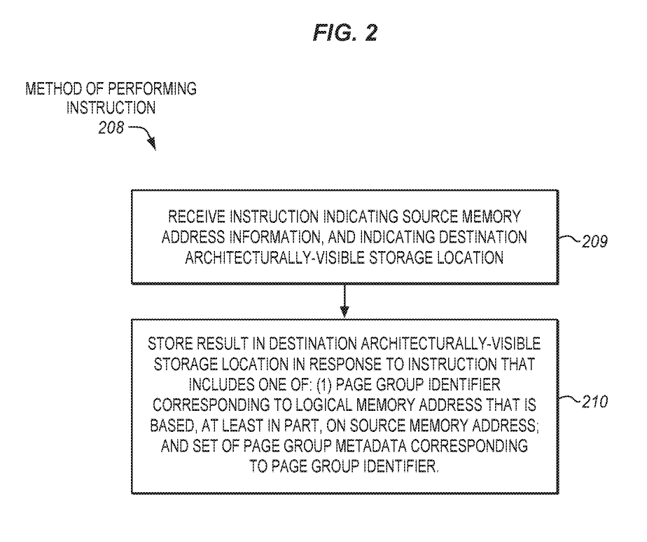

FIG. 2 is a block flow diagram of an embodiment of a method 208 of performing an embodiment of a page group information determination instruction. In various embodiments, the method may be performed by a processor, instruction processing apparatus, digital logic device, or integrated circuit.

The method includes receiving the page group information determination instruction, at block 209. In various aspects, the instruction may be received at a processor or a portion thereof (e.g., an instruction fetch unit, a decode unit, a bus interface unit, etc.). In various aspects, the instruction may be received from an off-processor and/or off-die source (e.g., from memory, interconnect, etc.), or from an on-processor and/or on-die source (e.g., from an instruction cache, instruction queue, etc.). The page group information determination instruction may specify or otherwise indicate source memory address information, and may specify or otherwise indicate a destination architecturally-visible storage location.

A result may be stored in the destination architecturally-visible storage location in response to and/or as a result of the page group information determination instruction, at block 210. In some embodiments, the result may include one of: (1) a page group identifier corresponding to a logical memory address that is based, at least in part, on the source memory address; and (2) a set of page group metadata corresponding to the page group identifier. The page group information determination instruction may only support storing one of these options as the result (e.g., there is no requirement that the page group information determination instruction be capable of storing in the alternative both the page group identifier and the set of page group metadata as the result). In some embodiments, different instructions (e.g., different opcodes) may optionally be included, with one to store the page group identifier, and another to store the set of page group metadata. Examples of a suitable set of page group metadata includes, but is not limited to, access permissions (which in some embodiments are not actually used to control or regulate access as further explained below), application-specific metadata (e.g., one or more bits to convey information to an algorithm, application, or software), and a combination thereof. One example of a suitable page group identifier is a protection key, although the scope of the invention is not so limited.

The illustrated method involves architectural operations (e.g., those visible from a software perspective). In other embodiments, the method may optionally include one or more micro-architectural operations. By way of example, the instruction may be fetched, decoded, scheduled out-of-order, source operands may be accessed, an execution unit may perform micro-architectural operations to implement the instruction, etc. In some embodiments, the micro-architectural operations to implement the instruction may optionally include looking up or accessing a page group identifier from a translation look-aside buffer, or performing a page table walk with on-die address translation logic of a processor in the event of a TLB miss. In some embodiments, the micro-architectural operations to implement the instruction may optionally include using the page group identifier as an index, row number, entry number, or other selector, to identify or select the set of page group metadata from a register, table, data structure, or other page group metadata storage.

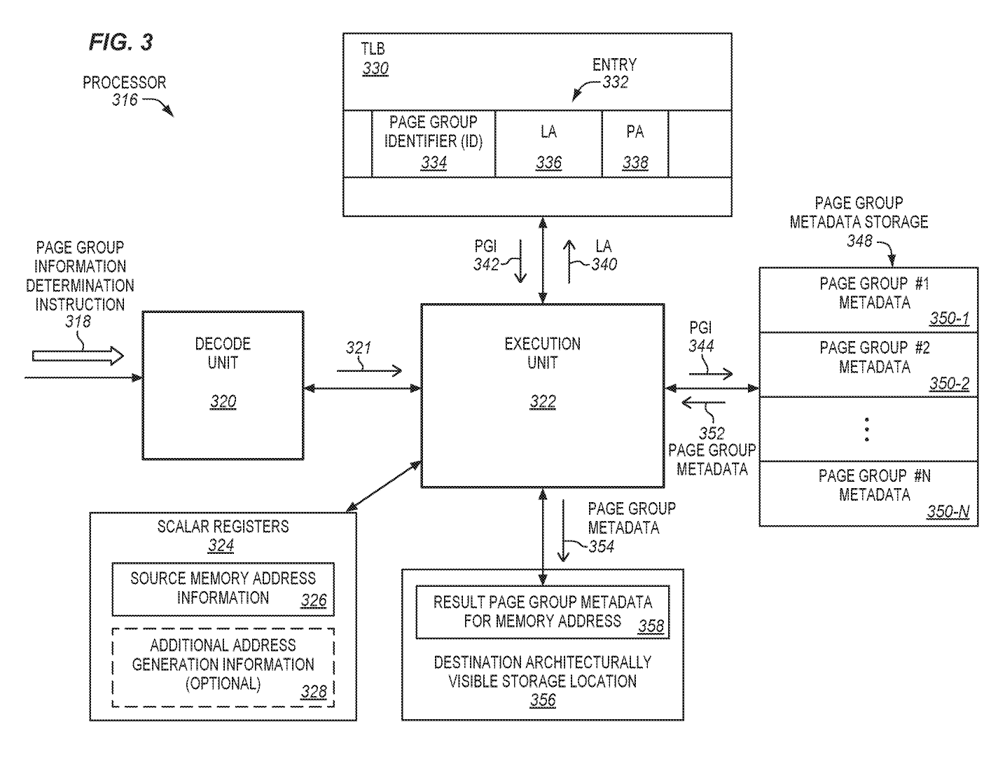

FIG. 3 is a block diagram of an embodiment of a processor 316 that is operative to perform an embodiment of a page group information determination instruction 318 to store result page group metadata 358 for an associated logical memory address 340. In some embodiments, the processor 316 may be operative to perform the method 208 of FIG. 2. The components, features, and specific optional details described herein for the processor 316 and/or the instruction 318 of FIG. 3, also optionally apply to the method 208. Alternatively, the method 208 may be performed by and/or within a similar or different processor or apparatus and/or using a similar or different instruction. Moreover, the processor 316 may perform methods the same as, similar to, or different than the method 208.

In some embodiments, the processor 316 may be a general-purpose processor (e.g., a general-purpose microprocessor or central processing unit (CPU) of the type used in desktop, laptop, or other computers). Alternatively, the processor may be a special-purpose processor. Examples of suitable special-purpose processors include, but are not limited to, network processors, communications processors, cryptographic processors, graphics processors, co-processors, embedded processors, digital signal processors (DSPs), and controllers (e.g., microcontrollers). The processor may have any of various complex instruction set computing (CISC) architectures, reduced instruction set computing (RISC) architectures, very long instruction word (VLIW) architectures, hybrid architectures, other types of architectures, or have a combination of different architectures (e.g., different cores may have different architectures). In some embodiments, the processor may include be disposed on at least one integrated circuit or semiconductor die. In some embodiments, the processor may include at least some hardware (e.g., transistors, on-die non-volatile memory storing microcode or other instructions, or the like).

During operation, the processor 316 may receive the page group information determination instruction 318. For example, the instruction may be received from memory over a bus or other interconnect. The instruction may represent a macroinstruction, assembly language instruction, machine code instruction, or other instruction or control signal of an instruction set of the processor. In some embodiments, the instruction may explicitly specify (e.g., through one or more fields or a set of bits), or otherwise indicate (e.g., implicitly indicate), a source memory address information 326. In some embodiments, the instruction may optionally explicitly specify (e.g., through one or more fields or a set of bits), or otherwise indicate (e.g., implicitly indicate), optional source additional address generation information 328. The source memory address information, and the optional additional address generation information, may each represent a source operand of the instruction. In some embodiments, the instruction may optionally explicitly specify (e.g., through one or more fields or a set of bits), or otherwise indicate (e.g., implicitly indicate), a destination architecturally visible storage location 356 where a result page group metadata 358 for the logical memory address is to be stored due to performing the instruction. The result page group metadata may represent a result operand of the instruction.

The page group information determination instruction may specify or indicate these operands in different ways in different embodiments. As one possible approach, the instruction may have source and/or destination operand specification fields within its instruction encoding to specify registers, memory locations, or other storage locations for the operands. As another possible approach, the instruction may have an immediate in its instruction encoding to provide an immediate value (e.g., for the source memory address information 326). As yet another possible approach, a register, memory location, or other storage location may optionally be inherent or otherwise implicit to the instruction (e.g., its opcode), without the instruction needing to have any non-opcode bits to explicitly specify the storage location. For example, the processor may inherently or otherwise implicitly understand to look in the implicit storage location to find the operand based on the recognition of the opcode. Combinations of such approaches may also optionally be used.

The source memory address information 326, and in some cases the optional additional address generation information 328, may be used to generate a virtual memory address, a linear memory address, or other logical memory address (LA) 340. This may be done in different ways in different embodiments. In some embodiments, the source memory address information may represent the fully formed virtual memory address or other logical memory address. In such embodiments, there may be no need for the optional additional address generation information. In other embodiments, both the source memory address information, and the additional address generation information, may be used to generate the logical memory address. This may be done in different ways depending upon the particular memory addressing mode or mechanism employed. By way of example, the source memory address information may optionally include a memory index or displacement, and the optional additional address generation information may include one or more of a scale factor, a base, and a segment. Other types of information may potentially be used for other memory addressing modes or mechanisms. The scope of the invention is not limited to any particular way in which the logical memory address may be generated.

Referring again to FIG. 3, in some embodiments, the source memory address information 326, and the optional additional address generation information 328, may optionally be stored in a set of general-purpose registers or other scalar registers 324 of the processor. Alternatively, other registers or other types of storage locations may optionally be used. Each of the scalar registers may represent an on-die (or on integrated circuit) storage location that is operative to store scalar data. The registers may represent architecturally-visible or architectural registers that are visible to software and/or a programmer and/or are the registers indicated by instructions of the instruction set of the processor to identify operands. These architectural registers are contrasted to other non-architectural registers in a given microarchitecture (e.g., temporary registers, reorder buffers, retirement registers, etc.). The registers may be implemented in different ways in different microarchitectures and are not limited to any particular type of design. Examples of suitable types of registers include, but are not limited to, dedicated physical registers, dynamically allocated physical registers using register renaming, and combinations thereof.

Referring again to FIG. 3, the processor includes a decode unit or decoder 320. The decode unit may receive and decode the page group information determination instruction 318. The decode unit may output one or more relatively lower-level instructions or control signals 321 (e.g., one or more microinstructions, micro-operations, micro-code entry points, decoded instructions or control signals, etc.), which reflect, represent, and/or are derived from the relatively higher-level page group information determination instruction. In some embodiments, the decode unit may include at least one input structure (e.g., a port, interconnect, or interface) to receive the page group information determination instruction, an instruction recognition and decode logic coupled therewith to recognize and decode the page group information determination instruction, and at least one output structure (e.g., a port, interconnect, or interface) coupled therewith to output the lower-level instruction(s) or control signal(s). The decode unit may be implemented using various different mechanisms including, but not limited to, microcode read only memories (ROMs), look-up tables, hardware implementations, programmable logic arrays (PLAs), other mechanisms suitable to implement decode units, and combinations thereof. In some embodiments, the decode unit may be included on a die (e.g., on die with the execution unit 322). In some embodiments, the decode unit may include at least some hardware (e.g., one or more of transistors, integrated circuitry, on-die read-only memory or other non-volatile memory storing microcode or other instructions).

In some embodiments, instead of the page group information determination instruction being provided directly to the decode unit, an instruction emulator, translator, morpher, interpreter, or other instruction conversion module may optionally be used. Various types of instruction conversion modules may be implemented in software, hardware, firmware, or a combination thereof. In some embodiments, the instruction conversion module may be located outside the processor, such as, for example, on a separate die and/or in a memory (e.g., as a static, dynamic, or runtime emulation module). By way of example, the instruction conversion module may receive the page group information determination instruction, which may be of a first instruction set, and may emulate, translate, morph, interpret, or otherwise convert the page group information determination instruction into one or more corresponding intermediate instructions or control signals, which may be of a second different instruction set. The one or more intermediate instructions or control signals of the second instruction set may be provided to a decode unit (e.g., decode unit 320), which may decode them into one or more lower-level instructions or control signals executable by native hardware of the processor (e.g., one or more execution units).

Referring again to FIG. 3, the execution unit 322 is coupled with the decode unit 320, is coupled with the scalar registers 324, is coupled with at least one translation lookaside buffer (TLB) 330, is coupled with the destination architecturally visible storage location 356, and is coupled with a page group metadata storage 348. In some embodiments, the execution unit may be on a die or integrated circuit (e.g., with the decode unit and optionally all the aforementioned illustrated components of the processor). The execution unit may receive the one or more decoded or otherwise converted instructions or control signals that represent and/or are derived from the page group information determination instruction. The execution unit may also receive the source memory address information 326, and optionally the additional address generation information 328. In some embodiments, the execution unit may be operative in response to and/or as a result of the page group information determination instruction (e.g., in response to one or more instructions or control signals 321 decoded from the instruction and/or in response to the instruction being decoded and/or in response to the instruction being provided to a decoder) to perform a set of operations to implement the page group information determination instruction 318.

In some embodiments, the execution unit 322 may be operative in response to and/or as a result of the page group information determination instruction 318 to use a virtual memory address, a linear memory address, or other logical memory address (LA) 340, which may be derived or generated from the source memory address information 326, and the optional additional address generation information 328, to obtain a corresponding page group identifier (PGI) 342. The PGI 342 may corresponds to the logical address 340 and/or its corresponding page. In virtualized memory the software that is being performed on the processor may not access a memory directly using physical memory addresses. Instead, the software may access the memory through virtual, linear, or other logical memory addresses. The logical address space or memory may be divided into blocks known as pages (e.g., of one or more sizes). The pages of the logical memory may be mapped to physical memory locations, such as blocks (e.g., of the same size) in the physical address space or memory known as memory frames or physical frames. The logical memory addresses may be converted to corresponding physical memory addresses in order to identify the appropriate physical frames or other locations in the memory.

In some embodiments, the processor may have at least one translation lookaside buffer (TLB) 330. In one aspect, there may be a single TLB. In another aspect, there may be multiple TLBs at different levels in a hierarchy. Each of the at least one TLB may cache or otherwise store previous logical to physical memory address translations. For example, after a page table walk has been performed to translate a logical address to a physical address, the address translation may be cached in the at least one TLB. Typically, the TLB may have different entries to store different address translations. If the cached address translations are needed again, within a short enough period of time, then the address translations may be retrieved relatively quickly from the TLB, instead of needing to perform relatively slower page table walks. The needed address translations either will be stored in the one or more TLBs, or will not be. A TLB “hit” occurs when a needed address translation is stored in the one or more TLBs. In the event of a TLB “hit” the needed address translation may be retrieved from the TLB entry, and the associated physical memory address may be used to access the corresponding physical location in the memory. Conversely, a TLB “miss” occurs when the needed address translation is not stored in the one or more TLBs. In the event of the TLB “miss,” a page table walk may be performed.

Referring again to FIG. 3, the logical address 340 may be provided as a lookup parameter, search key, or other input to the at least one TLB. As shown, in some embodiments, a given entry 332 in the at least one TLB, when the processor is in operation or use, may have a logical address (LA) 336 that matches or hits the input logical address 340. The given entry in the TLB may represent a copy of, or at least include data from, a corresponding page table entry in a page table. In some embodiments, the given entry 332 may also include a page group identifier field to provide a page group identifier (PGI) 334. In some embodiments, the page group identifier may include one or more bits (e.g., often from about one to about six bits) that may have a value to identify a particular page group of at least two different page groups. As one specific example, in certain IA-32e compliant processors (e.g., available from Intel Corporation, of Santa Clara, Calif.) the page group identifier field may represent bits [62:59] of the page table entry, which may be stored in a TLB entry, and which may be used to store a 4-bit protection key, although the scope of the invention is not so limited. This 4-bit protection key would not be used as an input for the address matching logic. The PGI 334 associated with a page may be acquired as an effectively free side effect of performing the page table lookup to fill in the TLB entry for the page, rather than needing to access the PGI from an application specific table. Accordingly, the instruction may cause the execution unit or processor to determine the page group identifier 334 corresponding to the logical address associated with the instruction and/or its corresponding page. A PGI 342 (e.g., a copy and/or the value of the page group identifier 334) may be returned or provided to the execution unit.

In some embodiments, the execution unit 322 may also be operative in response to and/or as a result of the page group information determination instruction 318 to use the page group indicator (PGI) 342 to identify, determine, or obtain corresponding or otherwise associated page group metadata 352. A page group indicator (PGI) 344 (e.g., copy of and/or the value of the PGI 342) may be provided to the page group metadata storage 348. The page group metadata storage may be operative, when the processor is in operation or use, to store at least two sets of page group metadata. In some embodiments, the page group metadata storage may represent one or more registers, on-die storage, or one or more other storage locations, into which to store the at least two sets of page group metadata. Each set of the page group metadata may correspond to, or otherwise be associated with, a different one of the at least two different page group identifiers. In the illustrated embodiment, the page group metadata storage has a first page group #1 metadata 350-1 that corresponds to a first page group ID, a second page group #2 metadata 350-2 that corresponds to a second page group ID, through an Nth page group #N metadata 350-N that corresponds to an Nth page group ID. In one aspect, there may be a different set of (not necessarily different) page group metadata for each different page group ID. Either all or part of the page group identifier (e.g., all the bits or only some of them) may be used to select the corresponding set of page group metadata.

The page group indicator (PGI) 344 may be operative to identify, select, or determine a corresponding or associated set of page group metadata 350. By way of example, the PGI 344 may be used as an index, row number, entry number, or the like, to uniquely identify, select, or determine one of the sets of page group metadata from a register, table, data structure, or other page group metadata storage. By way of example, one specific suitable example of the page group metadata storage, in the IA-32e compliant processors, is a protection key rights register for user pages (PKRU), which has sixteen different fields each to store a set of access permissions for a corresponding page group. The PKRU may broadly represent an access permission register, table, data structure, structure, or storage that is operative to store different sets of access permissions. A 4-bit protection key may be used (e.g., as an example of a page group identifier) as an input to uniquely select one of the fields, and its corresponding access permissions (which may not necessarily actually be used to control access for the page group information determination instruction as explained further below). The selected set of page group metadata 352 may be returned to the execution unit.

In some embodiments, the execution unit 322 may be operative in response to and/or as a result of the page group information determination instruction 318 to store page group metadata 354 as result page group metadata 358 for the logical memory address 340 and/or its corresponding page. The result page group metadata may be stored in the destination architecturally visible storage location 356. In some embodiments, the destination architecturally visible storage location may be a flags register and/or one or more flags of the processor. As used herein the term flags broadly encompasses flags as well as analogous bits or indications referred to by different names, such as, for example, status bits, condition code bits, status flags, status indicators, and the like. Likewise, as used herein the term flags register broadly encompasses a flags register as well as analogous registers or sets of bit storage referred to by different names, such as, for example, a status register, condition code register, and the like. The architectural names and/or conventional typical uses of the flags or status bits may not be reflected in their use to store the metadata as disclosed herein. For example, the zero flag (instead of providing a zero indication as conventional) may instead indicate something unrelated to equaling zero such as that a page is within an evacuation region of garbage collection.

In some embodiments, each of two or more bits of the result metadata may optionally be stored in a different corresponding one of two or more flags. One possible advantage of using the one or more flags (as the destination architecturally visible storage location) is that often the instruction set of the processor may include one or more jump instructions, branch instructions, or other conditional control flow transfer instructions, which may perform a jump, branch, or other conditional control flow transfer operation based on the flags. This may allow control flow transfer to be performed directly using the result page group metadata of the page group information determination instruction. That is, the destination architecturally visible storage location of the page group metadata determination instruction may be a source operand, in some cases an implicit source operand, of one or more control flow transfer instructions, sometimes identified as conditional branch instructions. Alternatively, in other embodiments, the destination architecturally visible storage location may optionally be one of the scalar registers 324, or a location in memory, or another suitable storage location.

In some embodiments, the page group identifiers (e.g., PGI 334) may be configured exclusively by an operating system or other privileged system software, but not by user-level applications or unprivileged software. For example, the protection keys in the IA-32e compliant processors are generally configured by privileged system software. For example, the operating system may select the protection keys for different regions of memory from the available set of sixteen different protection key values available in order to “color” the memory for various different purposes. In some embodiments, the operating system or other privileged software may optionally provide an interface to allow a user-level application or unprivileged software to request that a specific page group ID be assigned to and/or associated with a given logical memory address or its corresponding page.

In contrast, in some embodiments, the page group metadata (e.g., the page group #1 metadata 350-1) in the page group metadata storage 348 may be capable of being modified directly by a user-level application and/or unprivileged software without needing assistance from and/or involvement of, and without needing to perform a transition into, the operating system or other privileged system software. For example, the access permissions in the PKRU may be capable of being modified directly by a user-level application. The PKRU may broadly represent an access permission register, table, data structure, structure, or storage that is operative to store different sets of access permissions. One possible advantage is that the page group metadata may tend to be less expensive for a user-level application to alter, since there is no need to involve or switch to the operating system. Also, since the page group metadata is not directly included in the TLB, there is no need to flush any TLB entries, when the page group metadata is changed. Instead, once the page group identifiers have been configured for a given page, the page group metadata for that given page may be changed by a user-level application, without switching to and/or involvement of the operating system, and without needing to change or flush any TLB entries.

The execution unit 322 and/or the processor 316 may include specific or particular logic (e.g., transistors, integrated circuitry, or other hardware potentially combined with firmware (e.g., instructions stored in non-volatile memory) and/or software) that is operative to perform the page group information determination instruction 318 and/or store the result metadata 358 in response to and/or as a result of the page group information determination instruction (e.g., in response to one or more instructions or control signals decoded from the page group information determination instruction). In some embodiments, the execution unit may include at least one structure (e.g., a port, interconnect, or an interface) to receive source operands, circuitry or logic coupled therewith to receive and process the source operands and generate the result operand, and at least one output structures (e.g., a port, interconnect, an interface) coupled therewith to output the result operand.

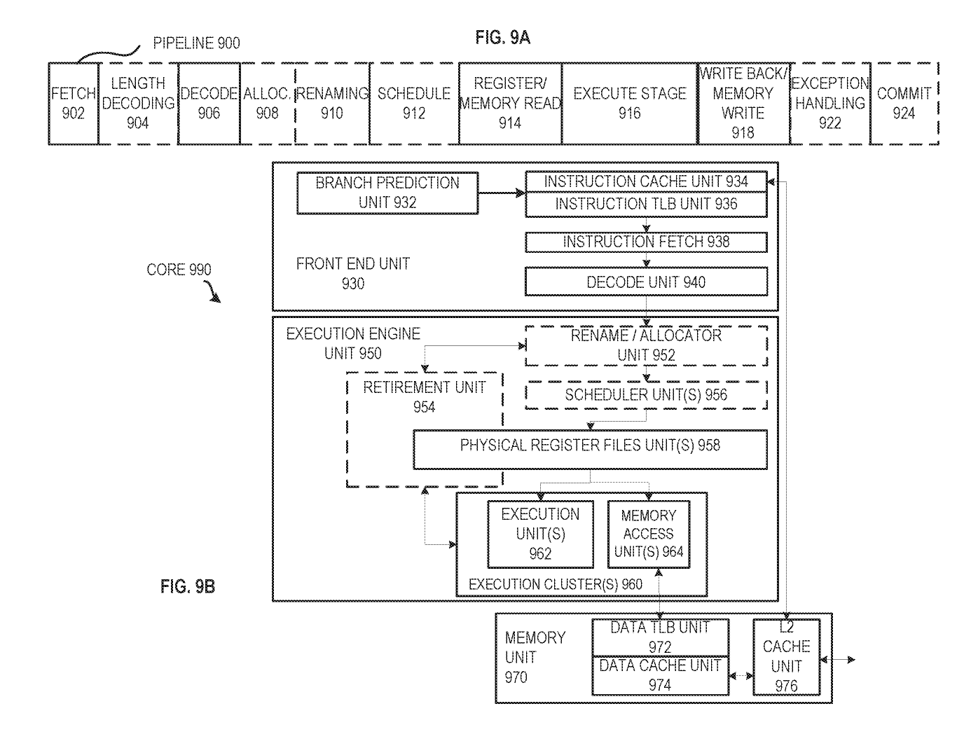

To avoid obscuring the description, a relatively simple processor 316 has been shown and described. However, the processor may optionally include other processor components. For example, various different embodiments may include various different combinations and configurations of the components shown and described for any of FIGS. 9B, 10A, 10B, 11. All of the components of the processor may be coupled together to allow them to operate as intended. By way of example, considering FIG. 9B, the instruction cache unit 934 may cache the instructions, the instruction fetch unit 938 may fetch the instruction, the decode unit 940 may decode the instruction, the scheduler unit 956 may schedule the associated operations, one of the execution units 962 may perform the instruction, the retirement unit 954 may retire the instruction, etc.

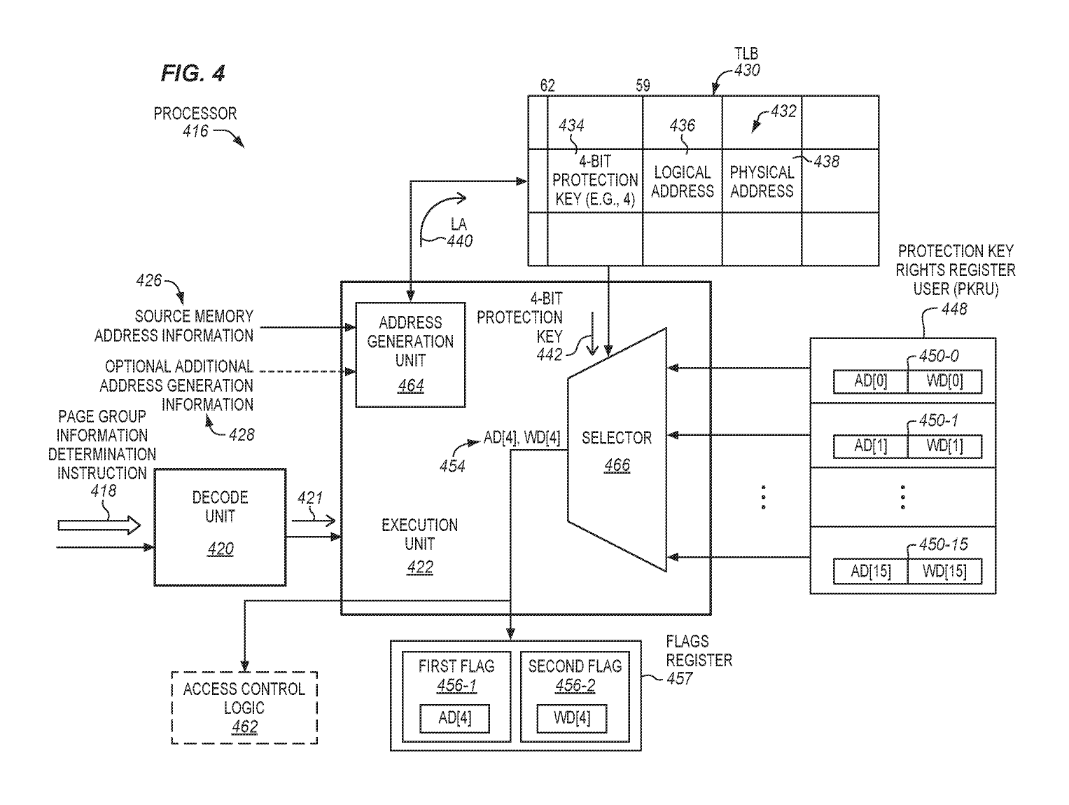

FIG. 4 is a block diagram of a detailed example embodiment of a processor 416 that is operative to perform an embodiment of a page group information determination instruction 418 to store result access permissions 454, associated with a protection key 434, for an associated logical memory address 440. The processor 416 may optionally be the same as, similar to, or different than, the processor 316 of FIG. 3. The processor includes a decode unit 420, an execution unit 422, and a TLB 430, and uses a source memory address information 426, and optional additional address generation information 428. Each of these components may optionally be similar to, or the same as, (e.g., have any one or more characteristics that are similar to or the same as), including the variations mentioned therefor, the correspondingly named components of FIG. 3. To avoid obscuring the description, the different and/or additional characteristics of the embodiment of FIG. 4 will primarily be described, without repeating all the characteristics which may optionally be the same as or similar to those described for the embodiment of FIG. 3. In some embodiments, the processor 416 may be operative to perform the method 208 of FIG. 2. The components, features, and specific optional details described herein for the processor 416 and/or the instruction 418 of FIG. 4, also optionally apply to the method 208. Alternatively, the method 208 may be performed by and/or within a similar or different processor or apparatus and/or using a similar or different instruction. Moreover, the processor 416 may perform methods the same as, similar to, or different than the method 208.

During operation, the decode unit 420 may decode the page group information determination instruction 418, and output one or more relatively lower-level instructions or control signals 421. The instruction may specify or otherwise indicate the source memory address information 426 and, in some embodiments, optionally the additional source address generation information 428. These operands may be indicated in the various different ways previously described.

The execution unit 422 is coupled with the decode unit 420, is coupled with the at least one TLB 430, is coupled with a protection key rights register for user pages (PKRU) 448, and is coupled with a flags register 457. An address generation unit 464 may be operative to use the source memory address information and, in some embodiments, the optional additional source address generation information, to generate a logical memory address (LA) 440.

In some embodiments, the execution unit 422 may be operative in response to and/or as a result of the page group information determination instruction 418 to use the logical memory address 440 to obtain a corresponding or associated 4-bit protection key 442. The logical address may be provided as a lookup parameter, search key, or other input to the at least one TLB 430. The TLB may be enhanced or extended so that each TLB entry result has a 4-bit protection key field. In IA-32e compliant processors, this field may correspond to bits [62:59] of the page table entry, which may be stored in the TLB entry. Each TLB entry may store a 4-bit protection key in its protection key field for the mapped, corresponding, or otherwise associated logical address. As shown, in some embodiments, a given entry 432 in the at least one TLB may have a logical address 436, which matches or hits the input logical address 440, as well as a corresponding physical address 438. In some embodiments, the given entry 432 may also include the associated 4-bit protection key 434. A 4-bit protection key 442 (e.g., a copy of and/or the value of the 4-bit protection key 434) may be provided to the execution unit (e.g., to a multiplexer or other selector 466).

In some embodiments, the execution unit 422 may be operative in response to and/or as a result of the page group information determination instruction 418 to use the 4-bit protection key 442 to index, select, identify, determine, or otherwise obtain a corresponding or associated set of access permissions 450 from the PKRU register 448. The selector 466 and/or the execution unit 422 may be coupled with the PKRU register. The PKRU register in the IA-32e compliant processors is a 32-bit register that has sixteen 2-bit fields or entries that each include a different set of memory access permissions 450. Each 2-bit field and/or its access permissions corresponds to and/or is associated with a different protection key. Specifically, the PKRU register has the following format: for each protection key i between 0 and 15, the bit PKRU[2i] is the access-disable bit (ADi) corresponding to and/or associated with that protection key i, and the bit PKRU[2i+1] is the write-disable bit (WDi) corresponding to and/or associated with that that protection key i. A first entry has a first set of access permissions 450-0 including first access-disable bit (AD0) and write-disable bit (WD0), a second entry has a second set of access permissions 450-1 including a second access-disable bit (AD1) and write-disable bit (WD1), and so on, through a sixteenth entry having a sixteenth set of access permissions 450-15 including a sixteenth access-disable bit (AD15) and write-disable bit (WD15).

The access permissions in the PKRU register are conventionally used as access permissions to control or regulate access to logical addresses and/or their pages. For example, the PKRU register is conventionally accessed as a side effect of load, store, and other memory access instructions. In such conventional accesses, if the access-disable bit (ADi) corresponding to a given protection key i is set to binary one, the processor may prevent any data accesses (e.g., reads or writes) to user-mode logical addresses that correspond to the given protection key i (e.g., as determined by the mappings in the TLB entries). Similarly, if the write-disable bit (WDi) corresponding to a given protection key i is set to binary one, the processor may prevent any write accesses to user-mode logical addresses that correspond to the given protection key i. The result of the access may either be an exception or fault (e.g., protection or page fault) if the access permissions are not appropriate for the access, or continued execution of the instruction. However, when used with the page group information determination as disclosed herein, using the access permissions to enforce or control access is not required, although it is not necessarily required to be excluded either. In some embodiments, the access permissions (even though they may be called that) may not be used for access control but rather may be repurposed and used in such a way that no faults, exceptions, or other such exceptional conditions are triggered regardless of the way that the access permissions are configured (e.g., no exceptional condition may be triggered even when the access disable bit is set to disable all data accesses (e.g., reads or writes). In some embodiments, a different PKRU register may optionally be provided for each of one or more hardware threads or other logical processors, although this is not required. It is to be appreciated that the PKRU register is just one illustrative example of a suitable page group metadata storage, but other types of page group metadata storage are also suitable. Also, it is to be appreciated that the access permissions represent just one suitable example of page group metadata, but other types of page group metadata are also suitable (e.g., one or more bits to convey information about garbage collection for a logical memory address and/or its page, one or more bits to convey information about whether a logical memory address and/or its page is being shared by another process, one or more bits to convey information about whether a logical memory address and/or its page is in relatively slower access memory or relatively faster access memory (e.g., for NUMA), or one or more bits to convey information useful to and/or pertaining to other algorithms, applications, or software).

In some embodiments, the selector 466 and/or the execution unit 422 may be operative to use the 4-bit protection key 442 as an index, row number, entry number, lookup value, or other input to uniquely identify, select, or determine the corresponding or associated access permissions 450. For example, each of the sixteen possible values of the 4-bit protection key may be operative to uniquely select a different corresponding one of the sixteen fields or entries in the PKRU. Specifically, for each protection key i between 0 and 15, the bit PKRU[2i] is the access-disable bit (ADi) corresponding to and/or associated with that protection key i, and the bit PKRU[2i+1] is the write-disable bit (WDi) corresponding to and/or associated with that that protection key i. As one specific example, if the protection key has the value of four, the bit PKRU[8] is the corresponding access-disable bit (AD4), and the bit PKRU[9] is the corresponding write-disable bit (WD4). Without limitations, in some embodiments, the determined access permissions may also optionally be provided to optional access control logic 462, although this may not be the case for other types of page group metadata.

As shown in the illustrated embodiment, the execution unit may be operative in response to and/or as a result of the page group information determination instruction to store the determined access permissions 454 (e.g., AD[4], WD[4]) in the flags register 457. For example, a first flag 456-1 and a second flag 456-2 of the flags register may be used to store two access permission bits. For example, the access-disable bit (AD) may be stored in one of the flags, and the write-disable bit (WD) may be stored in another of the flags. Either flag may be used for either access permission bit as desired for the particular implementation.

One possible advantage of using the one or more flags (as the destination architecturally visible storage location) is that often the instruction set of the processor may include one or more jump instructions, branch instructions, or other conditional control flow transfer instructions, which may perform a jump, branch, or other conditional control flow transfer operation based on the flags. This may allow control flow transfer to be performed directly using the result access permissions of the page group information determination instruction. That is, the destination architecturally visible storage location may represent a source operand, and in some cases an implicit source operand, of one or more control flow transfer instructions. Alternatively, other architecturally-visible destination storage locations may optionally be used, such as, for example, general-purpose registers, scalar registers, or memory locations.

In some embodiments, the protection keys (e.g., protection key 434) may be configured exclusively by an operating system or other privileged system software, but not by user-level applications or unprivileged software. For example, the operating system may select the protection keys for different regions of memory from the available set of sixteen different protection key values available in order to “color” the memory for various different purposes. In some embodiments, the operating system or other privileged software may optionally provide an interface to allow a user-level application or unprivileged software to request that a specific protection key be assigned to and/or associated with a given logical memory address or its corresponding page.

In contrast, in some embodiments, the access permissions (e.g., the access permissions 450-0) in the PKRU 448 may be capable of being modified directly by a user-level application and/or unprivileged software without needing assistance from and/or involvement of, and without needing to perform a transition into, the operating system or other privileged system software. Accordingly, the protection keys may provide a mechanism through which paging may be used to control or enforce access to user-mode logical addresses in a way that is under user-level control. One possible advantage is that the access permissions in the PKRU may tend to be less expensive for a user-level application to alter, since there is no need to involve or switch to the operating system. Also, since the access permissions are not directly included in the TLB, there is no need to flush any TLB entries, when the access permissions are changed. Instead, once the access permissions have been configured for a given page, the access permissions for that given page may be changed by a user-level application, without switching to and/or involvement of the operating system, and without needing to change or flush any TLB entries.

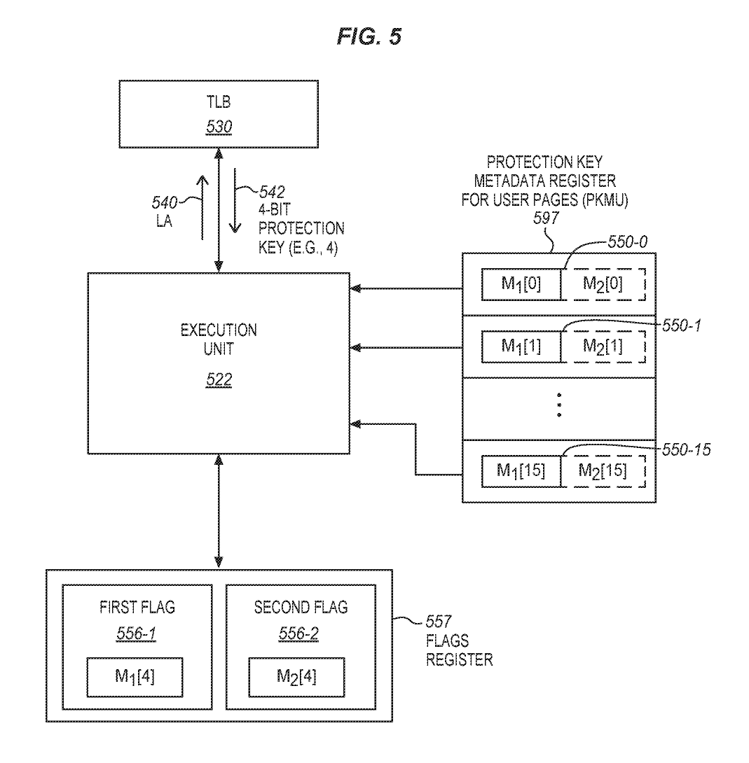

FIG. 5 is a block diagram of a detailed example embodiment of a processor 516 that is operative to perform an embodiment of a page group information determination instruction to store result page group metadata (e.g., M1[4], M2[4]), associated with a memory protection key 542, for an associated logical memory address 540. The processor 516 may optionally be the same as, similar to, or different than, the processor 316 of FIG. 3 and/or the processor 416 of FIG. 4. The processor includes an execution unit 522, and a TLB 530. Each of these components may optionally be similar to, or the same as, (e.g., have any one or more characteristics that are similar to or the same as), including the variations mentioned therefor, the correspondingly named components of FIG. 3 and/or FIG. 4. To avoid obscuring the description, the different and/or additional characteristics of the embodiment of FIG. 5 will primarily be described. In some embodiments, the processor 516 may be operative to perform the method 208 of FIG. 2. The components, features, and specific optional details described herein for the processor 516 also optionally apply to the method 208. Alternatively, the method 208 may be performed by and/or within a similar or different processor or apparatus and/or using a similar or different instruction. Moreover, the processor 516 may perform methods the same as, similar to, or different than the method 208.

The execution unit 522 is coupled with the at least one TLB 530, is coupled with a protection key metadata register for user pages (PKMU) 597, and is coupled with a flags register 557. In some embodiments, the execution unit 522 may be operative in response to and/or as a result of the page group information determination instruction to use the logical memory address 540 to obtain a corresponding or associated 4-bit protection key 542 from the at least one TLB. This may be done substantially as previously described. In some embodiments, the 4-bit protection key 542 may optionally be of the same general type as the 4-bit protection key 442, although the scope of the invention is not so limited. In some embodiments, the protection keys (e.g., the 4-bit protection key 542) may be modified or configured exclusively by privileged system software, but not by user-level applications or unprivileged software, as previously described.

In some embodiments, the execution unit 522 may be operative in response to and/or as a result of the page group information determination instruction to use the 4-bit protection key 542 to obtain a corresponding or associated set of metadata 550 (e.g., application-specific metadata) from the protection key metadata for user pages (PKMU) register 548. In some embodiments, the PKMU register may represent a register, table, data structure, or storage that is distinct from the PKRU. In some embodiments, the PKMU may optionally have a same number of entries as the PKRU (e.g., sixteen) so that the same 4-bit protection keys used for the PKRU may also optionally be reused or leveraged for the PKMU, although this is not required. Each entry in the PKMU may include at least one bit, or optionally two or more bits. In the illustrated embodiment, a first entry has a first set of metadata 550-0 that includes a first metadata bit (M1[0]) and optionally includes a second metadata bit (M2[0]), a second entry has a second set of metadata 550-1 that includes a first metadata bit (M1[1]) and optionally includes a second metadata bit (M2[1]), and a sixteenth entry has a sixteenth set of metadata 550-15 that includes a first metadata bit (M1[15]) and optionally includes a second metadata bit (M2[15]).

In contrast to a PKRU (e.g., the PKRU 448), the metadata bits in the PKMU 597 do not necessarily need to represent access permissions, but rather may optionally be allowed to represent various different types of application-specific bits, indicators, or metadata to convey information to an application about the associated logical memory address, or still other different types of metadata desired for the particular implementation. As one example, in some embodiments, one or more bits may optionally be included to convey information pertinent to garbage collection for the associated logical memory address and/or its page. One possible first bit, for such an example, may indicate whether the logical memory address is in an evacuation region of memory that is to be undergoing garbage collection. Another possible second bit, for such an example, may indicate whether the logical memory address is accessible (e.g., readable and/or writable) to the application. In other embodiments, one or more bits may optionally be included to convey information pertinent to other types of algorithms, applications, or software. As one example, one or more bits may optionally be included to convey information about whether a logical memory address and/or its page is being shared by another process. As another example, one or more bits may optionally be included to convey information about whether a logical memory address and/or its page is in relatively slower access memory or relatively faster access memory (e.g., in a NUMA environment). In some embodiments, the metadata 550 in the PKMU 548 may be capable of being modified or configured by a user-level application and/or unprivileged software without needing assistance from and/or involvement of, and without needing to perform a transition into, privileged system software.

As shown in the illustrated embodiment, the execution unit may be operative in response to and/or as a result of the page group information determination instruction to store the determined metadata (e.g., M1[4], M2[4] when protection key indicates the fourth entry) in the flags register 557. For example, a first flag 556-1 may be used to store one metadata bit (e.g., M1[4]) and a second flag 556-2 of the flags register may be used to store another metadata bit (e.g., M1[4]). The use of the one or more flags as the destination architecturally visible storage location may have possible advantages, as previously described.

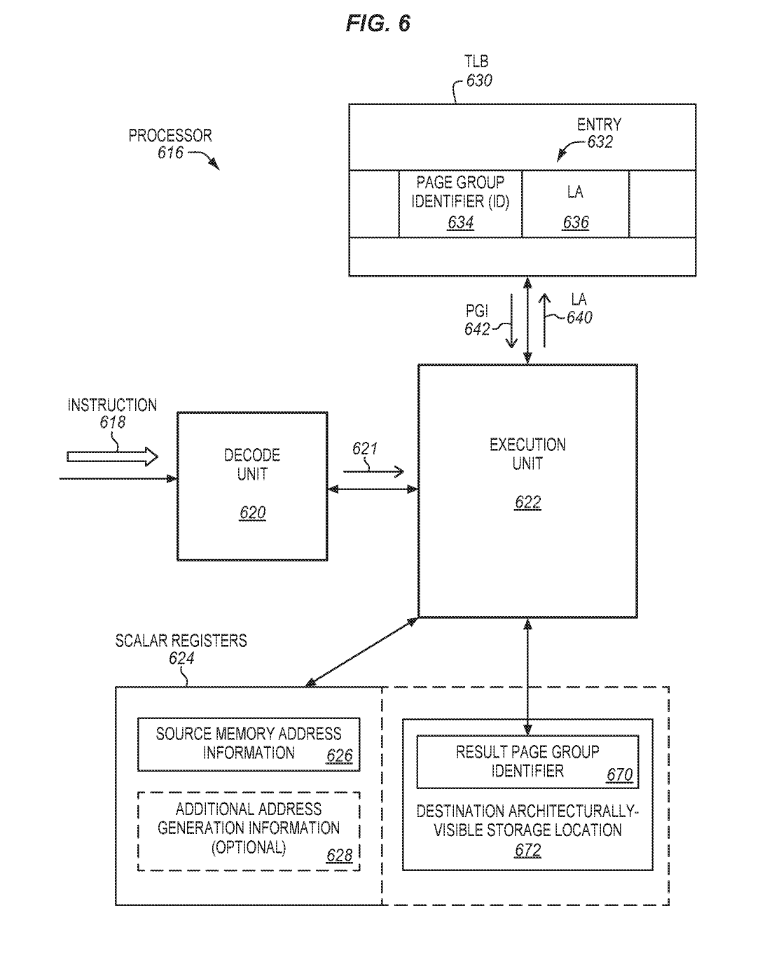

FIG. 6 is a block diagram of a detailed example embodiment of a processor 616 that is operative to perform an embodiment of a page group information determination instruction 618 to store a result page group identifier 670 for an associated logical memory address 640. The processor 616 may optionally be the same as, similar to, or different than, the processor 316 of FIG. 3 and/or the processor 416 of FIG. 4 and/or the processor 516 of FIG. 5. The processor includes a decode unit 620, an execution unit 622, and a TLB 630, and uses a source memory address information 626, and optional additional address generation information 628. Each of these components may optionally be similar to, or the same as, (e.g., have any one or more characteristics that are similar to or the same as including the variations mentioned therefor) the corresponding components of FIG. 3 and/or FIG. 4 and/or FIG. 5. To avoid obscuring the description, the different and/or additional characteristics of the embodiment of FIG. 6 will primarily be described.

The processor may receive the page group information determination instruction 618. In some embodiments, the instruction may indicate the source memory address information 626, and in some embodiments optionally the additional source address generation information 628. In some embodiments, the source memory address information, and the optional additional address generation information, may be stored in a set of scalar registers 624, although this is not required. In some embodiments, the instruction may optionally explicitly specify (e.g., through one or more fields or a set of bits), or otherwise indicate (e.g., implicitly indicate), a destination architecturally visible storage location 672, where a result page group identifier 670 is to be stored due to performing the instruction. The result page group identifier may represent a result operand of the instruction. These operands may be specified or otherwise indicated in the various ways previously described.

The decode unit 620 may decode the page group information determination instruction 618. The decode unit may output one or more relatively lower-level instructions or control signals 621. The execution unit 622 is coupled with the decode unit and may receive the lower-level instructions or control signals. The execution unit 622 is also coupled with the scalar registers 624, is coupled with at least one translation lookaside buffer (TLB) 630, and is coupled with the destination architecturally visible storage location 672.

In some embodiments, the execution unit 622 may be operative in response to and/or as a result of the page group information determination instruction 618 (e.g., in response to one or more instructions or control signals 621 decoded from the instruction and/or in response to the instruction being decoded and/or in response to the instruction being provided to a decoder) to use a logical memory address (LA) 640 to obtain a corresponding page group identifier (PGI) 642. The logical memory address may be derived or generated from the source memory address information, and in some embodiments optionally the additional address generation information, as previously described. The PGI corresponds to the logical address and/or its corresponding page. The logical address may be provided as an input to the at least one TLB as previously described. A given entry 632 in the at least one TLB may have a logical address (LA) 636 that matches or hits the input logical address 640. In some embodiments, the given entry 632 may also include a page group identifier field to provide a page group identifier (PGI) 634. The PGI 634 may be similar to or the same as those previously described and have the same variations. In some embodiments, the PGI may be a 4-bit protection key, although the scope of the invention is not so limited. A page group identifier 634 (e.g., a copy and/or value of the PGI 634) may be provided to the execution unit.

In some embodiments, the execution unit 622 may be operative in response to and/or as a result of the page group information determination instruction 618 to store the PGI 642 as a result page group identifier 670 in the destination architecturally visible storage location 672. The result page group identifier may be a copy of and/or have the same value as the page group identifier 634. The result page group identifier may correspond to or otherwise be associated with the logical memory address 640 and/or its corresponding page. As shown, in some embodiments, the destination architecturally visible storage location may optionally be one of the set of scalar registers 624 (e.g., a general-purpose register). Alternatively, other registers, a memory location, or other storage location may optionally be used.

In the embodiment of FIG. 6, the result page group identifier 670 is stored instead of page group metadata (e.g., the result page group metadata 358 as of FIG. 3). If desired, in some embodiments, the result page group identifier may optionally be converted to its corresponding page group metadata. As one example, a separate lookup (e.g., in a separate instruction) may optionally be performed with the result page group identifier 670 into a page group metadata storage. As another example, software may optionally maintain a copy of the data from the page group metadata storage and/or otherwise maintain a mapping of the result page group identifier 670 to its corresponding page group metadata. In still other cases, the result page group identifier 670 may be useful and/or of interest by itself without any need to obtain the corresponding page group metadata. In some embodiments, an application may use the result page group identifier to provide an application-specific indication (e.g., related to garbage collection or otherwise). For example, this may be done when there is no other purpose for the page group identifier and the number of metadata bits that are needed less than or equal to the number of bits of the page group identifier.

In the description above for FIGS. 3-6 it has been assumed that a TLB “hit” occurs. However, in some cases, a TLB “miss” may be encountered when performing a page group information determination instruction. Such a TLB miss may occur when the sought address translation for a logical memory address is not cached or stored in the at least one TLB, and likewise the corresponding page group identifier (PGI) may not be stored in the at least one TLB.

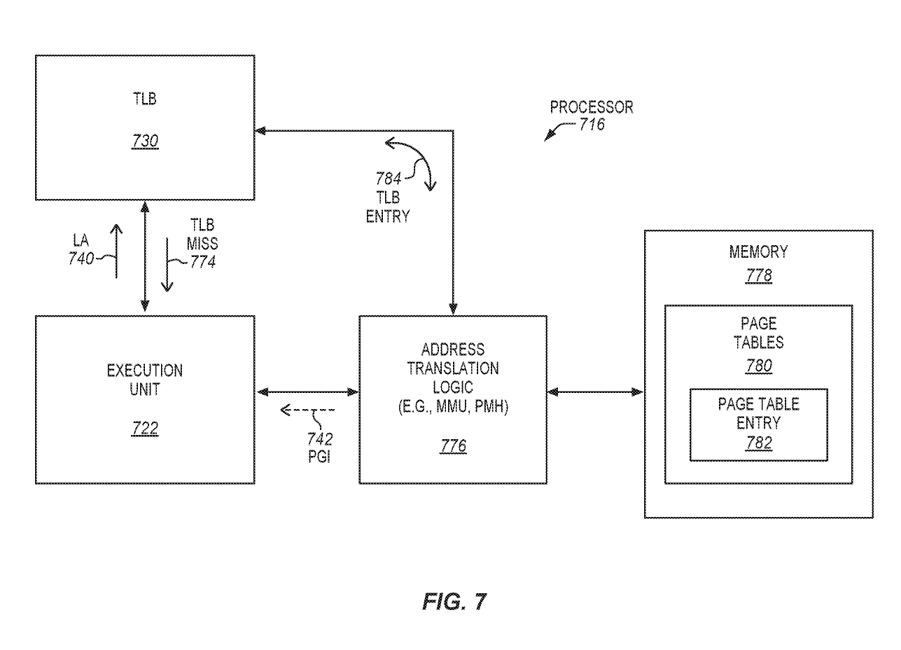

FIG. 7 is a block diagram of an embodiment of a processor 716 that is operative to perform an embodiment of a page group information determination instruction with a TLB miss 774 and a page table walk. An execution unit 722 may provide a logical address 740 to at least one TLB 730 as previously described. The TLB may signal a TLB miss 774. The TLB miss may be directed to address translation logic 776 of the processor. The address translation logic may be operative to perform a page table walk, or otherwise access a set of page tables 780, which may be stored in memory 778, in order to determine a page group identifier 742 and a TLB entry 784 having the sought address translation. The page tables may include a page table entry 782 having the sought address translation. The page table entry may also include the PGI 742. In some embodiments, the address translation logic may optionally be operative to directly provide the PGI 742 to the execution unit. In other embodiments, the address translation logic may store the TLB entry including the PGI in the at least one TLB, and the execution unit may be operative to obtain the PGI from the TLB entry. The execution unit may be operative to use the PGI in the various different ways described herein (e.g., store it as a result register, or use it to obtain page group metadata).

Examples of suitable address translation hardware include, but are not limited to, a memory management unit (MMU), a page miss handler (PMH), and other on-die logic of the processor that is perform a page table walk and/or check the page tables. The address translation logic may be implemented in on-die hardware (e.g., integrated circuitry, transistors or other circuit elements, etc.), on-die firmware (e.g., ROM, EPROM, flash memory, or other persistent or non-volatile memory and microcode, microinstructions, or other lower-level instructions stored therein), software (e.g., higher-level instructions stored in memory), or a combination thereof (e.g., predominantly hardware and/or firmware potentially combined with a relatively lesser amount of software).

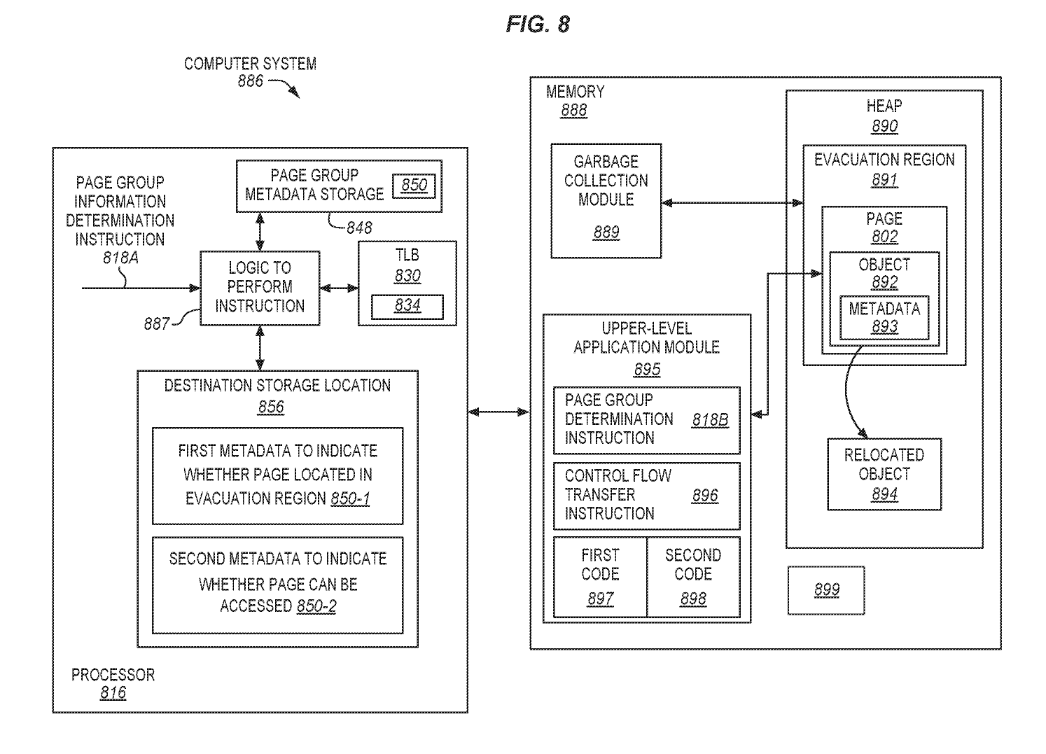

FIG. 8 is a block diagram of an embodiment of a computer system 886 that illustrates one possible use of a page group information determination instruction 818A in conjunction with garbage collection. The computer system includes a processor 816 and a memory 888. The processor and the memory may be coupled with one another.

The memory includes a garbage collection module 889. The garbage collection module may be operative to perform garbage collection. Garbage collection generally represents a type of automatic memory management that is commonly used in computer systems that provides an alternative to manual memory management. By way of example, garbage collection may be used in Java (e.g., OpenJDK Java), C#, Go, Microsoft .NET Framework, and various other managed-heap runtime environments. The garbage collection module may include algorithms or code to inspect objects (e.g., portions of software and/or data), including a given object 892, which may be stored on a heap 890, in order to determine which objects are still being used, and which objects are no longer being used. Commonly, the objects that are still being used represent referenced objects that are still being referenced by an active program (e.g., pointed to by a pointer). Such objects that are still being used are also sometimes referred to as live objects. Conversely, the objects that are no longer being used may represent unreferenced objects that are no longer being referenced by any active programs (e.g., are not being pointed to by any active or live pointers). The unused objects are also sometimes referred to as dead objects or garbage. In garbage collection such unused objects may be deleted and the memory used for them may be freed or reclaimed.

The garbage collection module 889 may be any of various different types. The page group determination instruction can be used to implement software-based garbage collection load, read and/or write barriers for concurrent copy garbage collectors. Examples of suitable types of garbage collection algorithms include, but not limited to, concurrent or runtime copy compacting garbage collectors, concurrent or runtime garbage collection algorithms that are able to relocate still in use objects from a current page to another page before recycling the current page as free memory, concurrent or runtime garbage collection algorithms that use an evacuation region, generational garbage collection algorithms, and various other forms of concurrent or runtime garbage collection algorithms, including new forms of garbage collection algorithms not yet developed, but which may also benefit from the embodiments described herein. Specific illustrative examples of suitable copy compacting garbage collectors include, but are not limited to, the Zing® garbage collector from Azul Systems, Inc. of Sunnyvale, Calif., and the Shenandoah garbage collector from Red Hat, Inc., of Raleigh, N.C., although others may also be used.

In some embodiments, the garbage collection module 889 may perform garbage collection on a portion of the heap 890 known as an evacuation region 891. A given page 802 (e.g., a virtual memory page) may be located within the evacuation region. The give page includes a given object 892. During garbage collection, the given object 892 may be relocated from within the evacuation region to outside the evacuation region as a relocated object 894. For example, the objects may be moved out of the evacuation region so they can be copy-compacted in a different region. A user-level application module 895 during use may access and/or use pages including the given page 802 and objects on the heap including the given object 892. In some embodiments, the user-level application module may include a page group information determination instruction 818B that may indicate the given page 802 and may be used to obtain information pertaining to garbage collection for the indicated given page prior to accessing the object 892.

The processor 816 may perform the page group information determination instruction 818A indicating the given page 802. The processor includes logic 887 to perform the page group information determination instruction (e.g., a decode unit and an execution unit). The processor includes at least one TLB 830 to store a protection key, or other page group identifier, for the given page. The processor also includes a page group metadata storage 848 to store metadata 850 (e.g., repurposed access permission bits or garbage-collection specific metadata) for the given page. In some embodiments, the processor may store the metadata 850 in a destination storage location when performing the instruction, although in other embodiments this may optionally be performed by one or more additional instructions as previously described.

In some embodiments, the metadata may include a first metadata 850-1 (e.g., one or more bits) to indicate whether the given page 802 and/or an encompassed logical address is located within an evacuation region such as the evacuation region 891 of the heap that is currently being evacuated by garbage collection (e.g., by a copy-compacting garbage collection module). For example, in some embodiments, every page within the evacuation region may be assigned a particular value of a protection key or other page group identifier to indicate that the page is within the evacuation region. In some embodiments, the metadata may include a second metadata 850-2 (e.g., one or more bits) to indicate whether the given page 802 can be accessed (e.g., read from and/or written to). The second metadata may effectively indicate whether the object 892 is still present in the evacuation region (e.g., as either the object itself or metadata 893 that indicates where the object has been relocated) and may be accessed, or if it has already removed from the evacuation region after being relocated to the relocated object. In one aspect, if the object is still present in the evacuation region, in some embodiments, metadata 893 may be stored in or with the object to indicate where the object is going to be relocated to (e.g., a memory address of the relocated object 894). So, if the second metadata bit indicates the object is still in the evacuation region, then either the object itself may be accessed or the metadata 893 may be accessed to determine the location of the relocated object. Otherwise, if the object is not still present in the evacuation region another approach may be needed to find the relocated object (e.g., a hash table or other separate data structure 899 may be consulted). In other embodiments, only one of these metadata may optionally be used. In still other embodiments, other types of metadata may optionally be used to provide different and/or additional information or indications. These metadata may either represent repurposed protection keys or application specific metadata.

The instruction may be performed before accessing the given page to inform information about the page to inform the user-level application if the page can be accessed and how it can be accessed. In some embodiments, the user-level application 895 may include a control flow transfer instruction 896 that may be used to conditionally perform a control flow transfer based on the metadata in the destination storage location 856. In some embodiments, the user-level application may include a first portion of code 897 that may be performed if the metadata provides one indication (e.g., if the page is not in the evacuation region), and a second portion of code 898 that may be performed if the metadata provides another indication (e.g., if the page is in the evacuation region). Advantageously, the page group information determination instruction and the logic to perform it may help to improve the performance of the user-level application in the presence of garbage collection.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

Exemplary Core Architectures

In-Order and Out-of-Order Core Block Diagram

FIG. 9A is a block diagram illustrating both an exemplary in-order pipeline and an exemplary register renaming, out-of-order issue/execution pipeline according to embodiments of the invention. FIG. 9B is a block diagram illustrating both an exemplary embodiment of an in-order architecture core and an exemplary register renaming, out-of-order issue/execution architecture core to be included in a processor according to embodiments of the invention. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 9B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Ca.; the ARM instruction set (with optional additional extensions such as NEON) of ARM Holdings of Sunnyvale, Ca.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

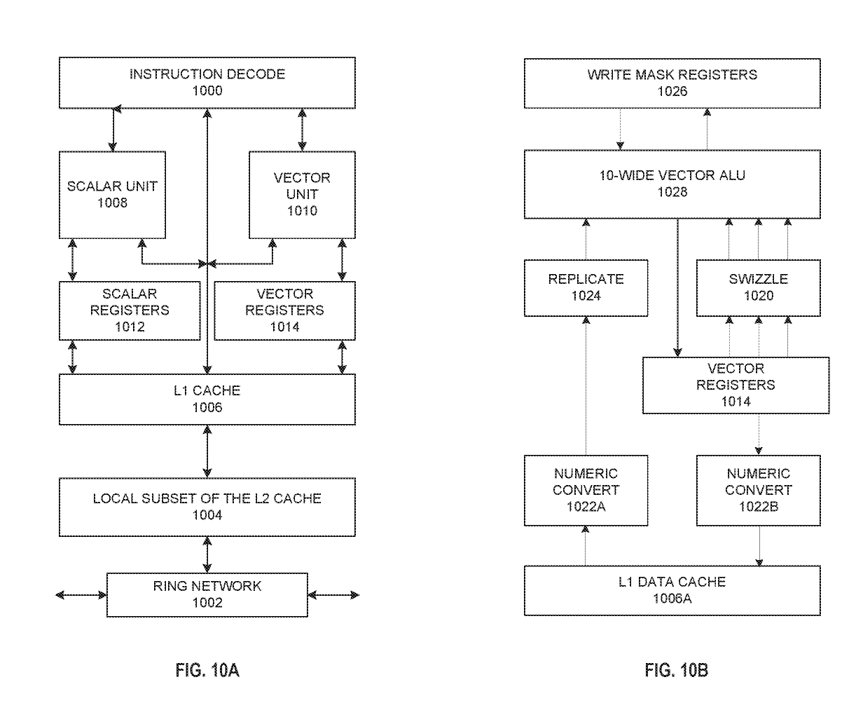

FIGS. 10A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 10A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 11012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 10B is an expanded view of part of the processor core in FIG. 10A according to embodiments of the invention. FIG. 10B includes an L1 data cache 1006A part of the L1 cache 1004, as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

Processor With Integrated Memory Controller and Graphics

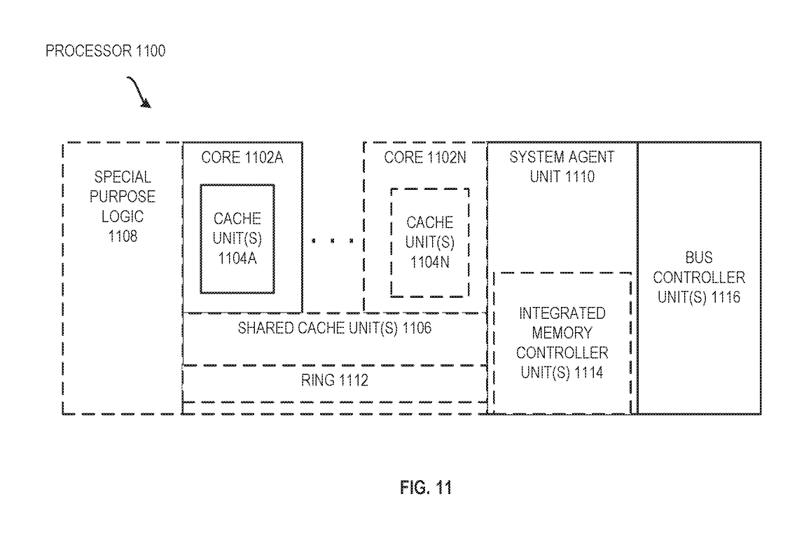

FIG. 11 is a block diagram of a processor 1100 that may have more than one core, may have an integrated memory controller, and may have integrated graphics according to embodiments of the invention. The solid lined boxes in FIG. 11 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

Exemplary Computer Architectures

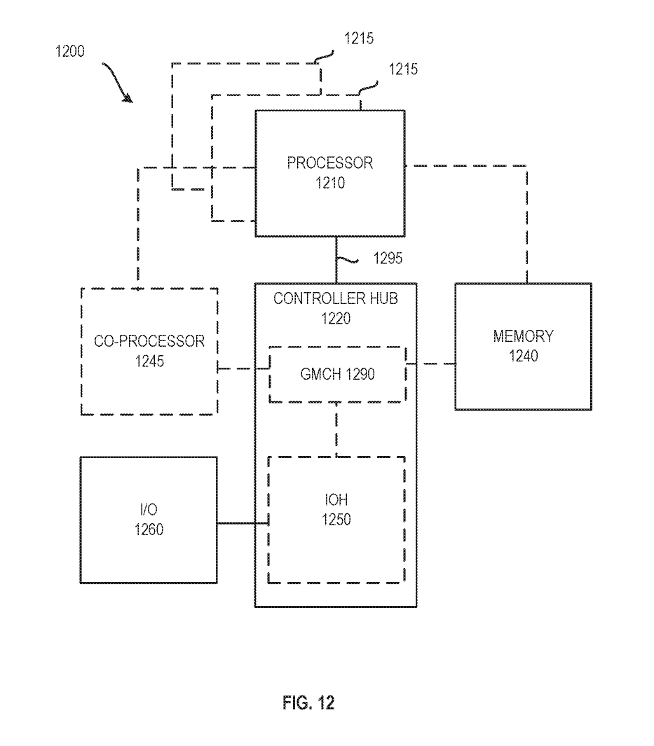

FIGS. 12-21 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 12, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 is couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 12 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

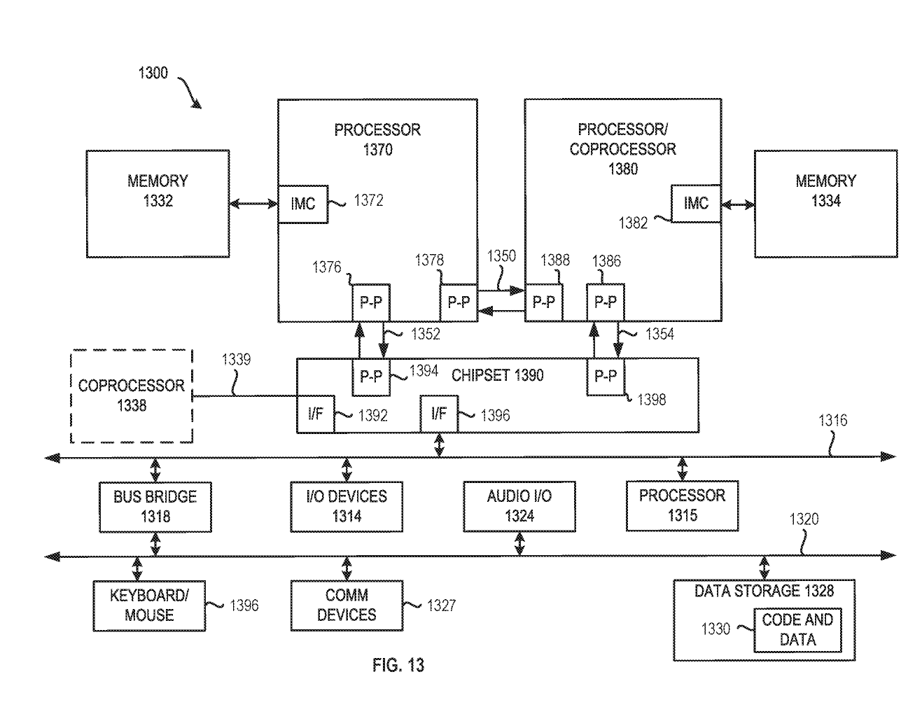

Referring now to FIG. 13, shown is a block diagram of a first more specific exemplary system 1300 in accordance with an embodiment of the present invention. As shown in FIG. 13, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 13, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 13, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 13, a system may implement a multi-drop bus or other such architecture.

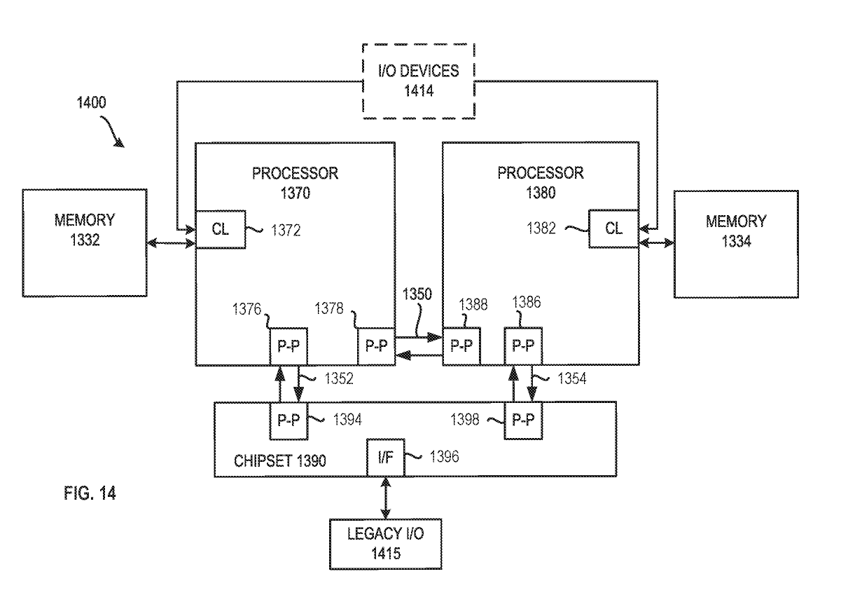

Referring now to FIG. 14, shown is a block diagram of a second more specific exemplary system 1400 in accordance with an embodiment of the present invention. Like elements in FIGS. 13 and 14 bear like reference numerals, and certain aspects of FIG. 13 have been omitted from FIG. 14 in order to avoid obscuring other aspects of FIG. 14.

FIG. 14 illustrates that the processors 1370, 1380 may include integrated memory and I/O control logic (“CL”) 1372 and 1382, respectively. Thus, the CL 1372, 1382 include integrated memory controller units and include I/O control logic. FIG. 14 illustrates that not only are the memories 1332, 1334 coupled to the CL 1372, 1382, but also that I/O devices 1414 are also coupled to the control logic 1372, 1382. Legacy I/O devices 1415 are coupled to the chipset 1390.

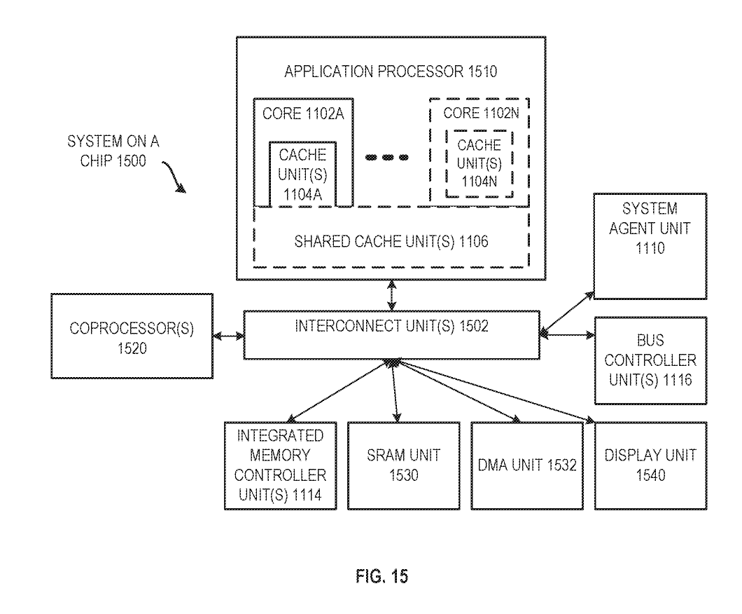

Referring now to FIG. 15, shown is a block diagram of a SoC 1500 in accordance with an embodiment of the present invention. Similar elements in FIG. 11 bear like reference numerals. Also, dashed lined boxes are optional features on more advanced SoCs. In FIG. 15, an interconnect unit(s) 1502 is coupled to: an application processor 1510 which includes a set of one or more cores 142A-N and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 13, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

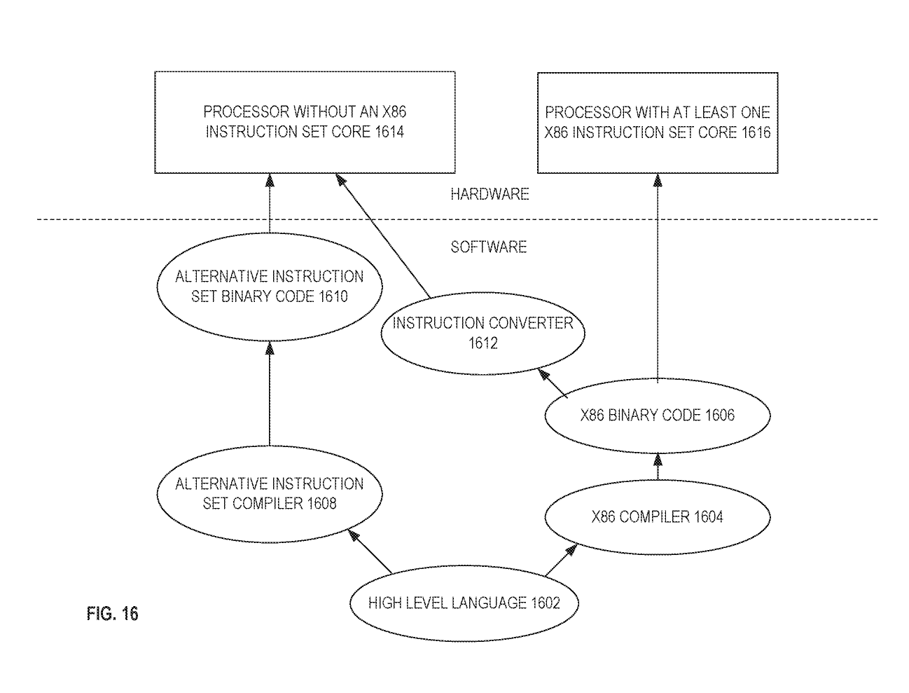

FIG. 16 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 16 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 16 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, CA and/or that execute the ARM instruction set of ARM Holdings of Sunnyvale, Ca.). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

Components, features, and details described for any of FIGS. 1, 4, 5, 7, and 8 may also optionally apply to any of FIGS. 2, 3, and 6. Components, features, and details described for any of the processors disclosed herein may optionally apply to any of the methods disclosed herein, which in embodiments may optionally be performed by and/or with such processors. Any of the processors described herein in embodiments may optionally be included in any of the systems disclosed herein (e.g., any of the systems of FIGS. 12-14).

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have be used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but yet still co-operate or interact with each other. For example, an execution unit may be coupled with a register and/or a decode unit through one or more intervening components. In the figures, arrows are used to show connections and couplings.

The term “and/or” may have been used. As used herein, the term “and/or” means one or the other or both (e.g., A and/or B means A or B or both A and B).

In the description above, specific details have been set forth in order to provide a thorough understanding of the embodiments. However, other embodiments may be practiced without some of these specific details. The scope of the invention is not to be determined by the specific examples provided above, but only by the claims below. In other instances, well-known circuits, structures, devices, and operations have been shown in block diagram form and/or without detail in order to avoid obscuring the understanding of the description. Where considered appropriate, reference numerals, or terminal portions of reference numerals, have been repeated among the figures to indicate corresponding or analogous elements, which may optionally have similar or the same characteristics, unless specified or clearly apparent otherwise.

Certain operations may be performed by hardware components, or may be embodied in machine-executable or circuit-executable instructions, that may be used to cause and/or result in a machine, circuit, or hardware component (e.g., a processor, potion of a processor, circuit, etc.) programmed with the instructions performing the operations. The operations may also optionally be performed by a combination of hardware and software. A processor, machine, circuit, or hardware may include specific or particular circuitry or other logic (e.g., hardware potentially combined with firmware and/or software) is operative to execute and/or process the instruction and store a result in response to the instruction.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Reference throughout this specification to “one embodiment,” “an embodiment,” “one or more embodiments,” “some embodiments,” for example, indicates that a particular feature may be included in the practice of the invention but is not necessarily required to be. Similarly, in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects lie in less than all features of a single disclosed embodiment. Thus, the claims following the Detailed Description are hereby expressly incorporated into this Detailed Description, with each claim standing on its own as a separate embodiment of the invention.

### EXAMPLE EMBODIMENTS

The following examples pertain to further embodiments. Specifics in the examples may be used anywhere in one or more embodiments.

Example 1 is a processor that includes a decode unit to decode an instruction. The instruction is to indicate a source memory address information, and the instruction is to indicate a destination architecturally-visible storage location. The processor also includes an execution unit coupled with the decode unit. The execution unit, in response to the instruction, is to store a result in the destination architecturally-visible storage location. The result is to include one of: (1) a page group identifier that is to correspond to a logical memory address that is to be based, at least in part, on the source memory address information; and (2) a set of page group metadata that is to correspond to the page group identifier.

Example 2 includes the processor of Example 1, in which the execution unit, in response to the instruction, is to store the result that is to include the set of page group metadata.

Example 3 includes the processor of Example 2, further including a translation lookaside buffer (TLB) to have an entry to store the page group identifier, and also optionally including a page group metadata storage to store the set of page group metadata.

Example 4 includes the processor of Example 3, in which the execution unit, in response to the instruction, is to obtain the page group identifier from the entry in the TLB, in which the entry in the TLB is to correspond to the logical memory address, and also optionally in which the execution unit is to use the page group identifier to obtain the set of page group metadata from the page group metadata storage.

Example 5 includes the processor of any one of Examples 3 to 4, in which the entry of the TLB is to have a 4-bit field to store a 4-bit protection key as the page group identifier, and also optionally in which the page group metadata storage is to include a 32-bit register that is to have sixteen sets of page group metadata each to be selected by a different value of the 4-bit protection key.

Example 6 includes the processor of any one of Examples 2 to 4, in which the set of page group metadata is to include at least one application-specific bit that is to convey information to an application about the logical memory address.

Example 7 includes the processor of Example 6, in which the at least one application-specific bit is to include a first application-specific bit that is to indicate whether the logical memory address is in an evacuation region of memory that is to be undergoing garbage collection.

Example 8 includes the processor of any one of Examples 6 to 7, in which the at least one application-specific bit is to include a second application-specific bit that is to indicate whether the logical memory address is accessible to the application.

Example 9 includes the processor of any one of Examples 2 to 5, in which the set of page group metadata is to include at least one access permission for the logical memory address.

Example 10 includes the processor of Example 9, wherein no exception and no fault is to be signaled while the instruction performed regardless of a configuration of the at least one access permission.

Example 11 includes the processor of any one of Examples 2 to 10, in which the destination architecturally-visible storage location is to include at least one bit in a flag register.

Example 12 includes the processor of any one of Examples 2 to 10, in which the set of page group metadata is to be modifiable at a user-level of privilege, and optionally in which the instruction is a user-level instruction.

Example 13 includes the processor of Example 1, in which the execution unit, in response to the instruction, is to store the result that is to include the page group identifier.

Example 14 includes the processor of Example 13, further including a translation lookaside buffer (TLB) to have an entry to store the page group identifier, and also optionally in which the execution unit, in response to the instruction, is to obtain the page group identifier from the entry in the TLB, in which the entry in the TLB is to correspond to the logical memory address.

Example 15 includes the processor of Example 14, in which the entry of the TLB is to have a 4-bit field to store a 4-bit protection key as the page group identifier.

Example 16 includes the processor of any one of Examples 13 to 15, in which the destination architecturally-visible storage location is to include a scalar register.

Example 17 includes the processor of any one of Examples 13 to 15, in which the page group identifier is not to be modifiable at a user-level of privilege.

Example 18 includes the processor of any one of Examples 13 to 15, in which the instruction is a user-level instruction.

Example 19 is a method performed by a processor that includes receiving an instruction at the processor. The instruction indicating a source memory address information, and the instruction indicating a destination architecturally-visible storage location. The method also includes storing a result in the destination architecturally-visible storage location in response to the instruction. The result includes one of: (1) a page group identifier corresponding to a logical memory address that is based, at least in part, on the source memory address information; and (2) a set of page group metadata corresponding to the page group identifier.

Example 20 includes the method of Example 19, in which said storing includes storing the result that includes the set of page group metadata. The method may also optionally include obtaining the page group identifier from an entry in a translation lookaside buffer (TLB) that corresponds to the logical memory address. The method may also optionally include using the page group identifier to obtain the set of page group metadata from a page group metadata storage.

Example 21 includes the method of Example 19, in which said storing includes storing the result that includes the page group identifier. The method may also optionally include obtaining the page group identifier from an entry in a translation lookaside buffer (TLB) that corresponds to the logical memory address.

Example 22 is a computer system that includes a bus or other interconnect, and a processor coupled with the interconnect. The processor to receive an instruction that is to indicate a source memory address information, and that is to indicate a destination architecturally-visible storage location. The processor, in response to the instruction, to store a result in the destination architecturally-visible storage location. The result to include a set of page group metadata that is to correspond to a page group identifier that is to correspond to a logical memory address that is to be based, at least in part, on the source memory address information. The computer system also includes a memory (e.g., a DRAM) coupled with the interconnect. The memory storing a set of instructions. The set of instructions, when executed by the processor, to cause the processor to perform operations including accessing the page group metadata from an application, and using the page group metadata to control flow in the application.

Example 23 includes the computer system of Example 22, in which the set of page group metadata is to include a first application-specific bit that is to indicate whether the logical memory address is in an evacuation region of memory that is to be undergoing garbage collection.

Example 24 is an article of manufacture that includes a non-transitory machine-readable storage medium. The non-transitory machine-readable storage medium storing a plurality of instructions including an instruction. The instruction, if performed by a machine, is to cause the machine to perform operations including access a source memory address information that is to be indicated by the instruction, and store a result in a destination architecturally-visible storage location, which is to be indicated by the instruction. The result to include one of: (1) a page group identifier that is to correspond to a logical memory address that is to be based, at least in part, on the source memory address information; and (2) a set of page group metadata that is to correspond to the page group identifier.

Example 25 includes the article of manufacture of Example 24, in which the instruction, if performed by the machine, is to cause the machine to store the result that is to include the set of page group metadata.

Example 26 includes the processor of any one of Examples 1 to 18, further including an optional branch prediction unit to predict branches, and an optional instruction prefetch unit, coupled with the branch prediction unit, the instruction prefetch unit to prefetch instructions including the instruction. The processor may also optionally include an optional level 1 (L1) instruction cache coupled with the instruction prefetch unit, the L1 instruction cache to store instructions, an optional L1 data cache to store data, and an optional level 2 (L2) cache to store data and instructions. The processor may also optionally include an instruction fetch unit coupled with the decode unit, the L1 instruction cache, and the L2 cache, to fetch the instruction, in some cases from one of the L1 instruction cache and the L2 cache, and to provide the instruction to the decode unit. The processor may also optionally include a register rename unit to rename registers, an optional scheduler to schedule one or more operations that have been decoded from the instruction for execution, and an optional commit unit to commit the instruction.

Example 27 includes a system-on-chip that includes at least one interconnect, the processor of any one of Examples 1 to 18 coupled with the at least one interconnect, an optional graphics processing unit (GPU) coupled with the at least one interconnect, an optional digital signal processor (DSP) coupled with the at least one interconnect, an optional display controller coupled with the at least one interconnect, an optional memory controller coupled with the at least one interconnect, an optional wireless modem coupled with the at least one interconnect, an optional image signal processor coupled with the at least one interconnect, an optional Universal Serial Bus (USB) 3.0 compatible controller coupled with the at least one interconnect, an optional Bluetooth 4.1 compatible controller coupled with the at least one interconnect, and an optional wireless transceiver controller coupled with the at least one interconnect.

Example 28 is a processor or other apparatus operative to perform the method of any one of Examples 19 to 21.

Example 29 is a processor or other apparatus that includes means for performing the method of any one of Examples 19 to 21.

Example 30 is an optionally non-transitory and/or tangible machine-readable medium, which optionally stores or otherwise provides instructions including a first instruction, the first instruction if and/or when executed by a processor, computer system, electronic device, or other machine, is operative to cause the machine to perform the method of any one of Examples 19 to 21.

Example 31 is a processor or other apparatus substantially as described herein.

Example 32 is a processor or other apparatus that is operative to perform any method substantially as described herein.

Example 33 is a processor or other apparatus that is operative to perform any page group information determination instruction substantially as described herein.

What is claimed is:

1. A processor comprising:
a decode unit to decode an instruction, the instruction to indicate a source memory address information, and the instruction to indicate a destination architecturally-visible storage location; and
an execution unit coupled with the decode unit, the execution unit, in response to the instruction, to store a result in the destination architecturally-visible storage location, the result to include one of:
a page group identifier that is to correspond to a logical memory address that is to be based, at least in part, on the source memory address information; and
a set of page group metadata that is to correspond to the page group identifier.

2. The processor of claim 1, wherein the execution unit, in response to the instruction, is to store the result that is to include the set of page group metadata.

3. The processor of claim 2, further comprising:
a translation lookaside buffer (TLB) to have an entry to store the page group identifier; and
a page group metadata storage to store the set of page group metadata.

4. The processor of claim 3, wherein the execution unit, in response to the instruction, is to:
obtain the page group identifier from the entry in the TLB, wherein the entry in the TLB is to correspond to the logical memory address; and
use the page group identifier to obtain the set of page group metadata from the page group metadata storage.

5. The processor of claim 3,
wherein the entry of the TLB is to have a 4-bit field to store a 4-bit protection key as the page group identifier; and
wherein the page group metadata storage is to include a 32-bit register that is to have sixteen sets of page group metadata each to be selected by a different value of the 4-bit protection key.

6. The processor of claim 2, wherein the set of page group metadata is to include at least one application-specific bit that is to convey information to an application about the logical memory address.

7. The processor of claim 6, wherein the at least one application-specific bit is to include a first application-specific bit that is to indicate whether the logical memory address is in an evacuation region of memory that is to be undergoing garbage collection.

8. The processor of claim 6, wherein the at least one application-specific bit is to include a second application-specific bit that is to indicate whether the logical memory address is accessible to the application.

9. The processor of claim 2, wherein the set of page group metadata is to include at least one access permission for the logical memory address.

10. The processor of claim 9, wherein no exception and no fault is to be signaled while the instruction performed regardless of a configuration of the at least one access permission.

11. The processor of claim 2, wherein the destination architecturally-visible storage location is to include at least one bit in a flag register.

12. The processor of claim 2, wherein the set of page group metadata is to be modifiable at a user-level of privilege, and wherein the instruction is a user-level instruction.

13. The processor of claim 1, wherein the execution unit, in response to the instruction, is to store the result that is to include the page group identifier.

14. The processor of claim 13, further comprising a translation lookaside buffer (TLB) to have an entry to store the page group identifier, and wherein the execution unit, in response to the instruction, is to obtain the page group identifier from the entry in the TLB, wherein the entry in the TLB is to correspond to the logical memory address.

15. The processor of claim 14, wherein the entry of the TLB is to have a 4-bit field to store a 4-bit protection key as the page group identifier.

16. The processor of claim 13, wherein the destination architecturally-visible storage location is to comprise a scalar register.

17. The processor of claim 13, wherein the page group identifier is not to be modifiable at a user-level of privilege.

18. The processor of claim 13, wherein the instruction is a user-level instruction.

19. A method performed by a processor comprising:
receiving an instruction at the processor, the instruction indicating a source memory address information, and the instruction indicating a destination architecturally-visible storage location; and
storing a result in the destination architecturally-visible storage location in response to the instruction, the result including one of:
a page group identifier corresponding to a logical memory address that is based, at least in part, on the source memory address information; and
a set of page group metadata corresponding to the page group identifier.

20. The method of claim 19, wherein said storing comprises storing the result that includes the set of page group metadata, and further comprising:
obtaining the page group identifier from an entry in a translation lookaside buffer (TLB) that corresponds to the logical memory address; and
using the page group identifier to obtain the set of page group metadata from a page group metadata storage.

21. The method of claim 19, wherein said storing comprises storing the result that includes the page group identifier, and further comprising obtaining the page group identifier from an entry in a translation lookaside buffer (TLB) that corresponds to the logical memory address.

22. A computer system comprising:
an interconnect;
a processor coupled with the interconnect, the processor to receive an instruction that is to indicate a source memory address information, and that is to indicate a destination architecturally-visible storage location, the processor, in response to the instruction, to store a result in the destination architecturally-visible storage location, the result to include a set of page group metadata that is to correspond to a page group identifier that is to correspond to a logical memory address that is to be based, at least in part, on the source memory address information; and
a memory coupled with the interconnect, the memory storing a set of instructions, the set of instructions, when executed by the processor, to cause the processor to perform operations comprising:
accessing the page group metadata from an application; and
using the page group metadata to control flow in the application.

23. The computer system of claim 22, wherein the set of page group metadata is to include a first application-specific bit that is to indicate whether the logical memory address is in an evacuation region of memory that is to be undergoing garbage collection.

24. An article of manufacture comprising a non-transitory machine-readable storage medium, the non-transitory machine-readable storage medium storing a plurality of instructions including an instruction, the instruction, if performed by a machine, is to cause the machine to perform operations comprising:
access a source memory address information that is to be indicated by the instruction; and
store a result in a destination architecturally-visible storage location, which is to be indicated by the instruction, in response to the instruction, the result to include one of:
a page group identifier that is to correspond to a logical memory address that is to be based, at least in part, on the source memory address information; and
a set of page group metadata that is to correspond to the page group identifier.

25. The article of manufacture of claim 24, wherein the instruction, if performed by the machine, is to cause the machine to store the result that is to include the set of page group metadata.
